(19) United States
(12) Patent Application Publication
(10) Pub. No.: US 2025/0125133 A1
(43) Pub. Date: Apr. 17, 2025

(54) Preventing Errors in Processing and Interpreting Mass Spectrometry Results

(71) Applicant: DH Technologies Development Pte. Ltd., #04-06 (SG)

(72) Inventors: David Michael Cox, Toronto (CA); Lyle Lorrence Burton, Woodbridge (CA)

(21) Appl. No.: 18/420,683

(22) PCT Filed: Jul. 5, 2022
(86) PCT No.: PCT/IB2022/056194

§ 371 Date: Jan. 23, 2024

Related U.S. Application Data
(60) Provisional application No. 63/225,143, filed on Jul. 23, 2021.

(51) Int. Cl. H01J 49/00; G01N 30/86

(52) U.S. Cl. CPC H01J 49/0036; G01N 30/86

(57) ABSTRACT

An analytical instrument produces intensity versus time measurements or intensity versus m/z measurements for each acquisition of n acquisitions using m instrument parameter values for each acquisition of n acquisitions, wherein n is a number greater than or equal to two and m is a number equal to or greater than one. For each acquisition of the n acquisitions, the instrument stores a data file that includes m one or more instrument parameter values applied to the instrument, producing n data files. A first data file of the n data files for a first acquisition is retrieved. A next data file of the n data files of a next acquisition is retrieved. The m corresponding parameter values of the first data file and the next data file are compared. If any corresponding parameter values differ between the first data file and the next data file, a notification of an instrument parameter difference corresponding to a name of the next data file is displayed.

### RELATED APPLICATIONS

This application claims the benefit of U.S. Provisional Patent Application Ser. No. 63/225,143, filed on Jul. 23, 2021, the content of which is incorporated by reference herein in its entirety.

### INTRODUCTION

The teachings herein relate to detecting different acquisition methods used for different sample acquisitions performed by an analytical instrument, such as a mass spectrometer. More particularly the teachings herein relate to systems and methods for comparing analytical instrument parameter values in the data files collected by an analytical instrument, notifying the user of differences in the parameter values, and allowing the user to quickly peruse the actual differences in the parameter values to determine if there is a problem with the data.

The systems and methods herein can be performed in conjunction with a processor, controller, or computer system, such as the computer system of FIG. 1.

### Combining Data Acquired With Different Instrument Parameters

Analytical instruments, such as mass spectrometers, can include a large number of different parameters that are used in each acquisition. An acquisition is, for example, a single elution or injection of a sample into the analytical instrument for analysis. The set of parameter values applied to an analytical instrument for an acquisition is referred to as an acquisition method.

An acquisition method is typically created using a user interface (UI) of the analytical instrument. Parameter values are set or default parameter values are accepted using one or more forms of the UI, for example. An acquisition method file or method file is then produced from the values entered in the UI and read by the analytical instrument control software. Alternatively, an acquisition method can be created by directly creating or editing an acquisition method file.

After an acquisition, a data file is created that includes the measurements taken by the analytical instrument and a copy of the parameter values of the acquisition method. There are generally three types of parameter values stored in the data file for the acquisition method. The first type of parameter value is a static value. This is a value that is set by the user per acquisition that is meant to stay the same throughout the entire acquisition. An exemplary static parameter of a mass spectrometer is the ion spray voltage.

The second type of parameter value is a dynamic value. This is a value that can vary dynamically during the acquisition within a certain range. As a result, a dynamic value is specified in the acquisition method as a range. An exemplary dynamic parameter of a mass spectrometer is the ion transmission control (ITC) parameter. In an acquisition method, the ITC parameter value may be set to between 1% and 100%, for example. This means that the ion current can be dynamically varied by the mass spectrometer between 1% and 100% in order to protect the detector or prevent saturation, for example.

The third type of parameter value is a measured parameter. This value is measured by the analytical instrument during the acquisition. This parameter value is not set in the acquisition method file but does appear in the data file. An exemplary measured parameter of a mass spectrometer is the ambient temperature.

As analytical instruments, such as mass spectrometers, have improved over the years, they have included more and more adjustable parameters. In addition, as the resolution of these instruments has improved, their measurements have become more and more sensitive to the parameter values that are used.

For example, mass spectrometry data is used in many analytical assays to detect, measure, confirm the presence of, and quantitate the amount of a compound. Reproducible and sensitive measurements are important characteristics of mass spectrometry analysis.

When acquiring data, the acquisition methods have access to many (hundreds) of instrument parameters that can impact the sensitivity and reproducibility of measurements. For example, changing the dwell time on a multiple reaction monitoring (MRM) transition can impact the variability of the measured signal and the noise detection. Or, changing the ion spray voltage can impact the spray stability and impact signal intensity or introduce different levels of background noise.

At the same time these analytical instruments have improved, they have found more and more uses across a wider set of applications. As a result, more and less experienced users of analytical instruments have been tasked with setting the parameter values of these instruments and analyzing their results.

For example, using mass spectrometry processing software (quantitation results tables), it is possible to combine data from several different acquisition methods. In some cases, this is done by design as the user may want to compare different instrument settings. However, in many cases, especially during routine analysis, users expect all data to have been acquired using the exact same acquisition method and instrument parameters.

Recently, a laboratory purchased a new mass spectrometer. During its evaluation of the instrument, it performed 40 different acquisitions of the same sample. In each acquisition, the mass spectrometer was used to quantify the known compound of the sample. The laboratory analyzed the measurements of the mass spectrometer and calculated a standard deviation or percent coefficient of variation (% CV) for the 40 acquisitions that was higher than they expected.

After a lengthy analysis of the laboratory's data by highly skilled scientists, the higher than expected % CV was found to be the result of a change in parameter settings between acquisitions. In particular, the laboratory applied an ion spray voltage of 5500 V to the first 20 acquisitions and an ion spray voltage of 4500 V to the last 20 acquisitions. Finding this difference from the mass spectrometer measurements was difficult and prone to error.

FIG. 2 is an exemplary plot 200 of the measured peak area of a known compound in percent versus acquisition number for an experiment in which a laboratory performed 40 different acquisitions of the same sample, upon which embodiments of the present teachings may be implemented. Plot 200 was created during the analysis of the laboratory's data and is not a plot that is normally produced. Plot 200, however, showed a difference between first 20 acquisitions 210 and last 20 acquisitions 220.

Due to noise, for example, no mass spectrometer can produce perfect accuracy and perfect precision. In plot 200, precision is the measure of how close each point is to the other points or the spreading out along the Y-axis. As a result, some loss in precision is expected in plot 200.

However, what was not expected in plot 200 was the large difference in between first 20 acquisitions 210 and last 20 acquisitions 220. To the highly skilled scientist, this was an indication that there was some difference in the acquisition method between first 20 acquisitions 210 and last 20 acquisitions 220. But, it was still not clear what parameter had changed. Only through considerable effort was it found that the ion spray voltage was set to 5500 V for first 20 acquisitions 210 and 4500 V for last 20 acquisitions 220.

In other words, only countless hours of tedious analysis of the hundreds of acquisition method parameter values in the 40 different data files uncovered the cause of the higher than expected % CV. This change in the ion spray voltage caused an incorrect % CV to be calculated.

It is not clear why two different ion spray voltages were used for first 20 acquisitions 210 and last 20 acquisitions 220. It is, however, clear that there was no intention of using two different ion spray voltages when evaluating the % CV of the mass spectrometer. Perhaps the person performing the acquisitions realized after first 20 acquisitions 210 that the ion spray voltage was incorrect and only wanted to analyze last 20 acquisitions 220 for the % CV of the mass spectrometer.

This, however, brings up another potential source of error. In many cases, the person who performs the acquisitions is not the same person that analyzes the data from the acquisitions. As a result, if it was not made clear to the person analyzing the data that the acquisition method changed, errors like the error in the calculation of the % CV of the mass spectrometer are possible.

Heretofore a solution to this problem of using different parameter values across acquisitions where the data is analyzed together has been to include a hierarchy of permissions in the creation of the acquisition methods. In other words, in order to prevent this problem, the software of analytical instruments has included permissions that only allow an administrator to change the parameter values of an acquisition. In addition, laboratories include standard operating procedures (SOPs) where someone analyzing the data between acquisitions is required to compare the dates of the acquisition method creation between acquisitions.

This solution has worked well for laboratories that are well regulated and have well-documented SOPs. However, as the use of analytical instruments is expanded beyond traditional areas and is increasingly used in academic and research pursuits, limiting access to instrument acquisition parameter values is often no longer possible.

As a result, additional systems and methods are needed to detect and alert users to changes in acquisition method parameters across acquisitions when data from those acquisitions are being analyzed together.

### LC-MS and LC-MS/MS Background

Mass spectrometry (MS) is an analytical technique for the detection and quantitation of chemical compounds based on the analysis of mass-to-charge ratios (m/z) of ions formed from those compounds. The combination of mass spectrometry (MS) and liquid chromatography (LC) is an important analytical tool for the identification and quantitation of compounds within a mixture. Generally, in liquid chromatography, a fluid sample under analysis is passed through a column filled with a chemically-treated solid adsorbent material (typically in the form of small solid particles, e.g., silica). Due to slightly different interactions of components of the mixture with the solid adsorbent material (typically referred to as the stationary phase), the different components can have different transit (elution) times through the packed column, resulting in separation of the various components. In LC-MS, the effluent exiting the LC column can be continuously subjected to MS analysis. The data from this analysis can be processed to generate an extracted ion chromatogram (XIC), which can depict detected ion intensity (a measure of the number of detected ions of one or more particular analytes) as a function of retention time.

In MS analysis, an MS or precursor ion scan is performed at each interval of the separation for a mass range that includes the precursor ion. An MS scan includes the selection of a precursor ion or precursor ion range and mass analysis of the precursor ion or precursor ion range.

In some cases, the LC effluent can be subjected to tandem mass spectrometry (or mass spectrometry/mass spectrometry MS/MS) for the identification of product ions corresponding to the peaks in the XIC. For example, the precursor ions can be selected based on their mass/charge ratio to be subjected to subsequent stages of mass analysis. For example, the selected precursor ions can be fragmented (e.g., via collision-induced dissociation), and the fragmented ions (product ions) can be analyzed via a subsequent stage of mass spectrometry.

### Tandem Mass Spectrometry or MS/MS Background

Tandem mass spectrometry or MS/MS involves ionization of one or more compounds of interest from a sample, selection of one or more precursor ions of the one or more compounds, fragmentation of the one or more precursor ions into product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. These workflows can include, but are not limited to, targeted acquisition, information dependent acquisition (IDA) or data dependent acquisition (DDA), and data independent acquisition (DIA).

In a targeted acquisition method, one or more transitions of a precursor ion to a product ion are predefined for a compound of interest. As a sample is being introduced into the tandem mass spectrometer, the one or more transitions are interrogated during each time period or cycle of a plurality of time periods or cycles. In other words, the mass spectrometer selects and fragments the precursor ion of each transition and performs a targeted mass analysis for the product ion of the transition. As a result, a chromatogram (the variation of the intensity with retention time) is produced for each transition. Targeted acquisition methods include, but are not limited to, multiple reaction monitoring (MRM) and selected reaction monitoring (SRM).

MRM experiments are typically performed using “low resolution” instruments that include, but are not limited to, triple quadrupole (QqQ) or quadrupole linear ion trap (QqLIT) devices. With the advent of “high resolution” instruments, there was a desire to collect MS and MS/MS using workflows that are similar to QqQ/QqLIT systems. High-resolution instruments include, but are not limited to, quadrupole time-of-flight (QqTOF) or orbitrap devices. These high-resolution instruments also provide new functionality.

MRM on QqQ/QqLIT systems is the standard mass spectrometric technique of choice for targeted quantification in all application areas, due to its ability to provide the highest specificity and sensitivity for the detection of specific components in complex mixtures. However, the speed and sensitivity of today's accurate mass systems have enabled a new quantification strategy with similar performance characteristics. In this strategy (termed MRM high resolution (MRM-HR) or parallel reaction monitoring (PRM)), looped MS/MS spectra are collected at high-resolution with short accumulation times, and then fragment ions (product ions) are extracted post-acquisition to generate MRM-like peaks for integration and quantification. With instrumentation like the TRIPLETOF® Systems of AB SCIEX™, this targeted technique is sensitive and fast enough to enable quantitative performance similar to higher-end triple quadrupole instruments, with full fragmentation data measured at high resolution and high mass accuracy.

In other words, in methods such as MRM-HR, a high-resolution precursor ion mass spectrum is obtained, one or more precursor ions are selected and fragmented, and a high-resolution full product ion spectrum is obtained for each selected precursor ion. A full product ion spectrum is collected for each selected precursor ion but a product ion mass of interest can be specified and everything other than the mass window of the product ion mass of interest can be discarded.

In an IDA (or DDA) method, a user can specify criteria for collecting mass spectra of product ions while a sample is being introduced into the tandem mass spectrometer. For example, in an IDA method a precursor ion or mass spectrometry (MS) survey scan is performed to generate a precursor ion peak list. The user can select criteria to filter the peak list for a subset of the precursor ions on the peak list. The survey scan and peak list are periodically refreshed or updated, and MS/MS is then performed on each precursor ion of the subset of precursor ions. A product ion spectrum is produced for each precursor ion. MS/MS is repeatedly performed on the precursor ions of the subset of precursor ions as the sample is being introduced into the tandem mass spectrometer. In proteomics and many other applications, however, the complexity and dynamic range of compounds is very large. This poses challenges for traditional targeted and IDA methods, requiring very high-speed MS/MS acquisition to deeply interrogate the sample in order to both identify and quantify a broad range of analytes.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a DIA method the actions of the tandem mass spectrometer are not varied among MS/MS scans based on data acquired in a previous precursor or survey scan. Instead, a precursor ion mass range is selected. A precursor ion mass selection window is then stepped across the precursor ion mass range. All precursor ions in the precursor ion mass selection window are fragmented and all of the product ions of all of the precursor ions in the precursor ion mass selection window are mass analyzed.

The precursor ion mass selection window used to scan the mass range can be narrow so that the likelihood of multiple precursors within the window is small. This type of DIA method is called, for example, MS/MS^{ALL}. In an MS/MS^{ALL} method, a precursor ion mass selection window of about 1 amu is scanned or stepped across an entire mass range. A product ion spectrum is produced for each 1 amu precursor mass window. The time it takes to analyze or scan the entire mass range once is referred to as one scan cycle. Scanning a narrow precursor ion mass selection window across a wide precursor ion mass range during each cycle, however, can take a long time and is not practical for some instruments and experiments.

As a result, a larger precursor ion mass selection window, or selection window with a greater width, is stepped across the entire precursor mass range. This type of DIA method is called, for example, SWATH acquisition. In a SWATH acquisition, the precursor ion mass selection window stepped across the precursor mass range in each cycle may have a width of 5-25 amu, or even larger. Like the MS/MS^{ALL} method, all of the precursor ions in each precursor ion mass selection window are fragmented, and all of the product ions of all of the precursor ions in each mass selection window are mass analyzed. However, because a wider precursor ion mass selection window is used, the cycle time can be significantly reduced in comparison to the cycle time of the MS/MS^{ALL} method.

U.S. Pat. No. 8,809,770 describes how SWATH acquisition can be used to provide quantitative and qualitative information about the precursor ions of compounds of interest. In particular, the product ions found from fragmenting a precursor ion mass selection window are compared to a database of known product ions of compounds of interest. In addition, ion traces or extracted ion chromatograms (XICs) of the product ions found from fragmenting a precursor ion mass selection window are analyzed to provide quantitative and qualitative information.

However, identifying compounds of interest in a sample analyzed using SWATH acquisition, for example, can be difficult. It can be difficult because either there is no precursor ion information provided with a precursor ion mass selection window to help determine the precursor ion that produces each product ion, or the precursor ion information provided is from a mass spectrometry (MS) observation that has a low sensitivity. In addition, because there is little or no specific precursor ion information provided with a precursor ion mass selection window, it is also difficult to determine if a product ion is convolved with or includes contributions from multiple precursor ions within the precursor ion mass selection window.

As a result, a method of scanning the precursor ion mass selection windows in SWATH acquisition, called scanning SWATH, was developed. Essentially, in scanning SWATH, a precursor ion mass selection window is scanned across a mass range so that successive windows have large areas of overlap and small areas of non-overlap. This scanning makes the resulting product ions a function of the scanned precursor ion mass selection windows. This additional information, in turn, can be used to identify the one or more precursor ions responsible for each product ion.

Scanning SWATH has been described in International Publication No. WO 2013/171459 A2 (hereinafter “the '459 Application”). In the '459 Application, a precursor ion mass selection window or precursor ion mass selection window of 25 Da is scanned with time such that the range of the precursor ion mass selection window changes with time. The timing at which product ions are detected is then correlated to the timing of the precursor ion mass selection window in which their precursor ions were transmitted.

The correlation is done by first plotting the m/z of each product ion detected as a function of the precursor ion m/z values transmitted by the quadrupole mass filter. Since the precursor ion mass selection window is scanned over time, the precursor ion m/z values transmitted by the quadrupole mass filter can also be thought of as times. The start and end times at which a particular product ion is detected are correlated to the start and end times at which its precursor is transmitted from the quadrupole. As a result, the start and end times of the product ion signals are used to determine the start and end times of their corresponding precursor ions.

### SUMMARY

A system, method, and computer program product are disclosed for detecting different acquisition methods used during sample analysis. The system includes an analytical instrument, a memory device, a processor, and a display device.

The analytical instrument produces intensity versus time measurements or intensity versus m/z measurements for each acquisition of n two or more sample acquisitions using m one or more instrument parameter values for each acquisition of n acquisitions. For each acquisition of the n acquisitions, the analytical instrument stores a data file that includes measurements for the acquisition and m one or more instrument parameter values applied to the analytical instrument for the acquisition in the memory device, producing n data files in the memory device.

The processor retrieves a first data file of the n data files for a first acquisition from the memory device. The processor retrieves a next data file of the n data files of a next acquisition from the memory device. The processor compares the m corresponding parameter values of the first data file and the next data file. If any corresponding parameter values differ between the first data file and the next data file, the processor displays a notification of an instrument parameter difference corresponding to a name of the next data file on the display device.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary plot of the measured peak area of a known compound in percent versus acquisition number for an experiment in which a laboratory performed 40 different acquisitions of the same sample, upon which embodiments of the present teachings may be implemented.

FIG. 3 is an exemplary listing of data file names produced by the analysis software of an analytical instrument, upon which embodiments of the present teachings may be implemented.

FIG. 4 is an exemplary listing of the data file names produced by the analysis software of an analytical instrument that includes an additional column with information notifying the user of any differences in parameter values of the data files, in accordance with various embodiments.

FIG. 5 is an exemplary listing of data files and their corresponding instrument parameter values in the form of a matrix, in accordance with various embodiments.

FIG. 6 is an exemplary listing of a rules file, in accordance with various embodiments.

FIG. 7 is a schematic diagram showing a system for detecting different acquisition methods used during sample analysis, in accordance with various embodiments.

FIG. 8 is a flowchart showing a method for detecting different acquisition methods used during sample analysis, in accordance with various embodiments.

FIG. 9 is a schematic diagram of a system that includes one or more distinct software modules that performs a method for detecting different acquisition methods used during sample analysis, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting. DESCRIPTION OF VARIOUS EMBODIMENTS

### Computer-Implemented System

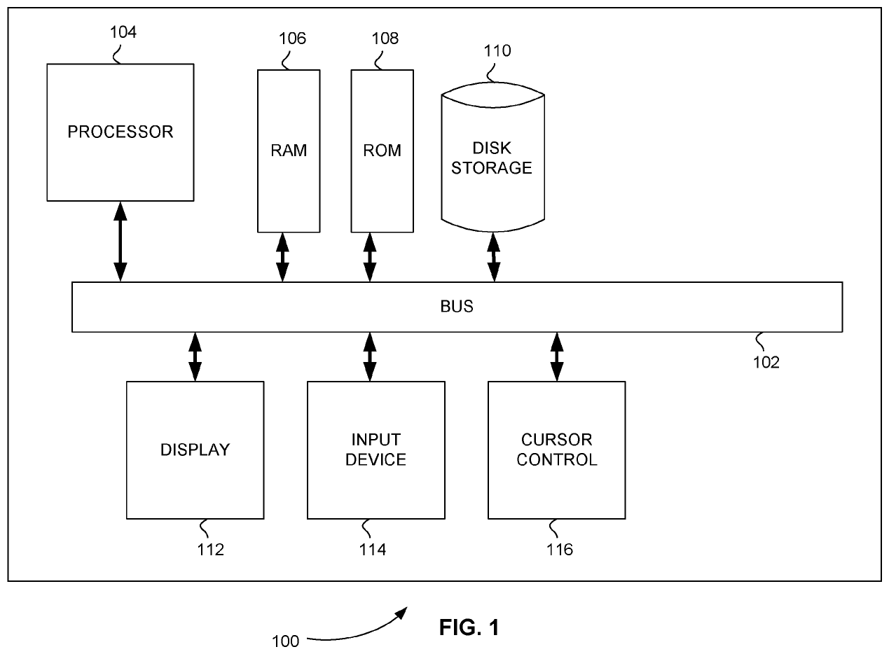

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus, implementations of the present teachings are not limited to any specific combination of hardware circuitry and software.

The term “computer-readable medium” or “computer program product” as used herein refers to any media that participates in providing instructions to processor 104 for execution. The terms “computer-readable medium” and “computer program product” are used interchangeably throughout this written description. Such a medium may take many forms, including but not limited to, non-volatile media, volatile media, and precursor ion mass selection media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Comparing Parameter Values Before Analysis

As described above, analytical instruments, such as mass spectrometers, can include a large number of different parameters that are used in each acquisition. As these analytical instruments have improved over the years, they have included more and more adjustable parameters. At the same time these analytical instruments have improved, they have found more and more uses across a wider set of applications. As a result, more and less experienced users of analytical instruments have been tasked with setting the parameter values of these instruments and analyzing their results.

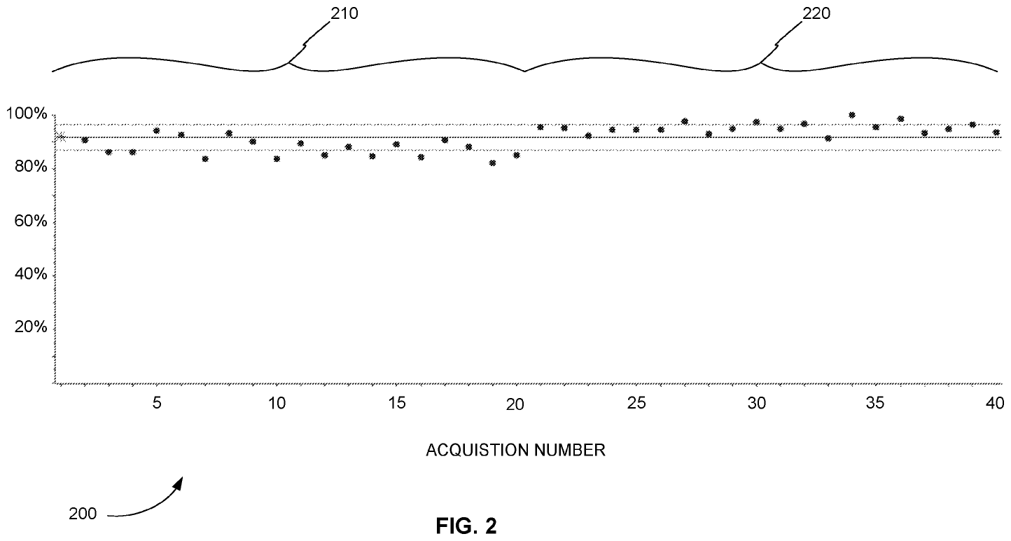

This is, in turn, has increased the likelihood of inadvertently using different parameter values across acquisitions where the data from these acquisitions is meant to be analyzed together. As described above and as shown in FIG. 2, using different parameter values across acquisitions can produce incorrect and unexpected results. Such errors can be very costly in terms of hours required to determine the cause of the errors.

This problem has previously been addressed by including a hierarchy of permissions in the creation of the acquisition methods. In other words, in order to prevent this problem, the software of analytical instruments has included permissions that only allow certain users to change the parameter values of an acquisition.

This solution has worked well for laboratories that are well regulated and have well-documented SOPs. However, as the use of analytical instruments is expanded beyond traditional areas and is increasingly used in academic and research pursuits, limiting access to instrument acquisition parameter values is often no longer possible.

As a result, additional systems and methods are needed to detect and alert users to changes in acquisition method parameters across acquisitions when data from those acquisitions are being analyzed together.

In various embodiments, when two or more data files produced by an analytical instrument are selected for analysis together, one or more instrument parameter values are compared among the two or more data files. If at least one instrument parameter value is different among the two or more data files, a difference in the acquisition method is detected and a notification of this difference is displayed for the user.

In various embodiments, the instrument parameter value that is compared among the two or more data files can be the modification date and time of the acquisition method file. The modification date and time of the acquisition method file provide the last date and time the instrument parameter values used for the acquisition were modified.

In various embodiments, only certain instrument parameter values that impact analysis results are compared among the two or more data files. These instrument parameter values are determined through expert knowledge, for example.

In various embodiments, all instrument parameter values are compared among the two or more data files. For example, all the instrument parameter values of a first data file can be compared to all the instrument parameter values of the other data files. Or, alternatively, all the instrument parameter values of each data file are compared to the corresponding values of every other data file.

In various embodiments, instrument parameter value changes are detected by comparing text values in the data file or using existing technology for tracking changes to important data, such as Git or blockchain.

As described above, dynamic instrument parameter values can vary dynamically during an acquisition within a certain range. For example, ITC values can vary during an acquisition and can impact quantitation. Knowing that this parameter has changed during the run (at the time the analyte was eluting), and changed differently than other samples, is useful to detect incorrect quantitation results. Therefore, in various embodiments, dynamic instrument parameter values among the two or more data files are compared to an acceptable range. If a value is detected outside of the acceptable range, a difference is detected and a notification of this difference is displayed for the user.

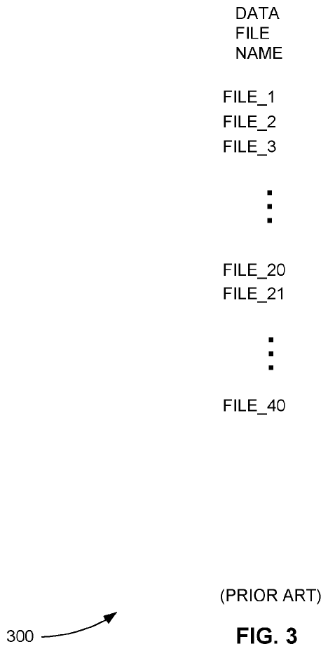

FIG. 3 is an exemplary listing 300 of data file names produced by the analysis software of an analytical instrument, upon which embodiments of the present teachings may be implemented. Typically, after selecting two or more data files for analysis, the analysis software of an analytical instrument displays a listing of those data files as shown in FIG. 3. Conventionally, there is no additional processing of these files to this point.

In various embodiments, after the selection of two or more data files for analysis and before displaying these data files, the analytical instrument parameter values of the data files are compared for any differences. In the listing of the data files, the user is then notified of any differences in the parameter values of the data files.

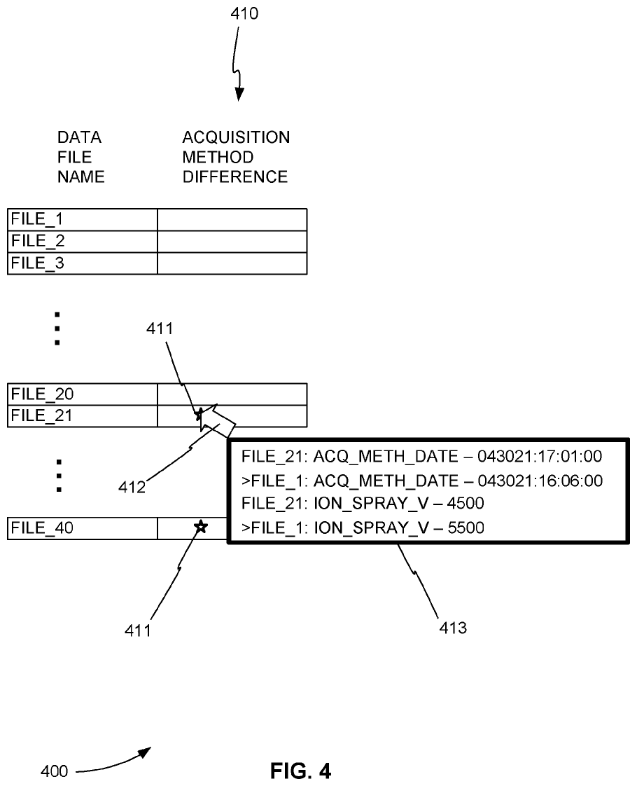

FIG. 4 is an exemplary listing 400 of the data file names produced by the analysis software of an analytical instrument that includes an additional column with information notifying the user of any differences in parameter values of the data files, in accordance with various embodiments. In comparison with listing 300 of FIG. 3, listing 400 of FIG. 4 includes additional column 410. Column 410 is used to notify a user that a difference in analytical instrument parameter values was detected after the data files were selected and before they were displayed. As described above, a difference in analytical instrument parameter values indicates that there is an acquisition method difference.

Icon 411 is used, for example, to notify the user that a file includes an acquisition method difference in comparison to one or more other files. Any type of icon can be used. In addition, icon 411 can be given a special color to indicate an acquisition method difference. In alternative embodiments, the element of column 410 next to a data file can include a different color to indicate an acquisition method difference. In that case, the icon is essentially the rectangular element of column 410. In FIG. 4, lines are shown to distinguish the column elements. In various alternative embodiments, lines are not shown to distinguish the column elements.

Notification of an acquisition method difference is important in cases where the user that is analyzing the data might assume that all the data was acquired with the same acquisition method difference. However, in many cases, the user that is analyzing the data is already aware that the data was acquired with different acquisition methods. As a result, as shown in FIG. 4, an icon that simply displays an acquisition method difference is unobtrusive for analyses that are not concerned with such a notification. In other words, displaying an icon or color provides enough information to notify the user but not too much information that may be unnecessary.

In various embodiments, the user interface displaying listing 400 can include a mouseover event that allows a user to obtain more information on an acquisition method difference by simply hovering mouse pointer 412 over an icon 411. This produces pop-up window 413, for example, that can display the actual acquisition method differences found.

Following the example described above in regard to FIG. 2, pop-up window 413 of FIG. 4 shows that two instrument parameter values differ between the acquisition method used to produce data file 21 and the acquisition method used to produce data file 1. In this case, the parameter values of data file 1 were compared to the parameter values of data file 21. The differing parameter values are the modification date and time of the acquisition method file and the ion spray voltage. Hovering mouse pointer 412 over icon 411 of data file 40 would produce a similar pop-up window to pop-up window 413.

For the example described above in regard to FIG. 2, all 20 data files 21 through 40 would have an icon 411 and a similar pop-up window to pop-up window 413. As a result, like FIG. 2, FIG. 4 quickly shows the user that two different acquisition methods were used for the 40 acquisitions represented by data files 1 through 40. However, unlike FIG. 2, the ability to immediately see the differences in acquisition parameters by hovering over an icon 411 allows the user to quickly determine the cause of the unexpected % CV value. As described above, the cause, in this case, was the difference in ion spray voltage.

In other words, FIG. 4 illustrates how the economic loss in terms of hours is prevented by comparing analytical instrument parameter values in the data files, notifying the user of differences, and allowing the user to quickly peruse the actual difference values. Further, it is important to note that, unlike FIG. 2, the error is uncovered in FIG. 4 by only looking at parameter values rather than actual measurements from the analytical instrument.

Also, note that FIG. 4 does not show an icon for data files 1 through 20. In various alternative embodiments, an icon can be displayed for each file. In this case, each file that has the same acquisition method parameter values would have the same icon or same color. Column 410 would then be labeled acquisition method rather than acquisition method difference. The user would then determine an acquisition method difference by seeing a difference in the icons or the colors.

As described above, analytical instruments can have on the order of hundreds of different parameters. As a result, pop-up window 413 of FIG. 4 can quickly become very complex if there are a lot of parameter value differences between acquisition methods. In various embodiments, parameter value differences are displayed for a user in the form of a matrix of parameter values and acquisition files.

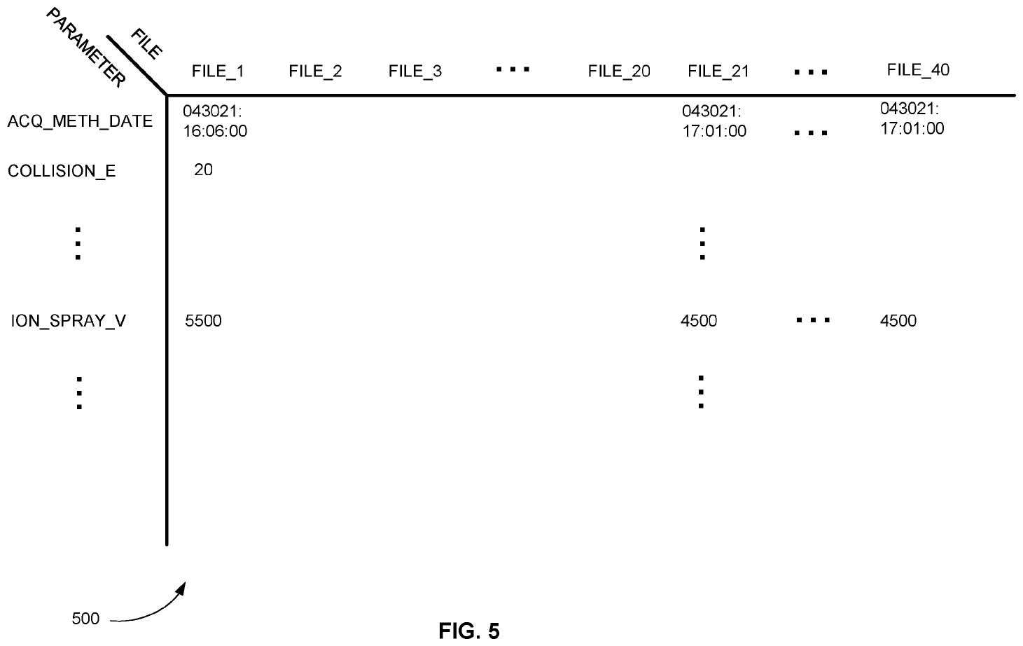

FIG. 5 is an exemplary listing 500 of data files and their corresponding instrument parameter values in the form of a matrix, in accordance with various embodiments. In listing 500, each row represents a different parameter of the analytical instrument and each column represents a data file or acquisition. In various embodiments, all the parameter values for the first data file are displayed in the column for the first data file. The first data file is compared to all of the other data files to find differences, so its parameters provide the basis for comparison. The basis for comparison is not limited to the first data file. Any data file can be used as a basis for comparison.

In various alternative embodiments, only the parameter values for the first data file that are found to have a difference in another data file are displayed in the column for the first data file. This reduces the complexity of the data and makes the differences more noticeable.

Parameter values of the other data files are only displayed as matrix elements if they vary from their corresponding values in the first data file. For example, the parameter values for the modification date and time of the acquisition method file of data files 21 and 40 are shown because they vary from their corresponding values in the first data file.

Again, FIG. 5 is following the example described above in regard to FIG. 2. Since the modification date and time of the acquisition method file differ from the first data file in the last 20 data files, each value for the modification date and time of the acquisition method file for the last 20 data files is displayed in FIG. 5. In contrast, there is no difference in the collision energy parameter value among the 40 different data files. As a result, the parameter value for collision energy is not displayed in FIG. 5 for any data file other than the first data file. As described above, in various embodiments, the collision energy for the first data file is also not shown since it is the same in all the other files.

In various alternative embodiments, all parameter values can be displayed. Of course, this makes it more difficult to discern the differences among the hundreds or thousands of parameter values.

FIG. 5 also shows that the ion spray voltage parameter value differs from the first data file in the last 20 data files. Again, like FIG. 2, FIG. 5 quickly shows the user that two different acquisition methods were used for the 40 acquisitions represented by data files 1 through 40. However, unlike FIG. 2, the ability to immediately see the differences in acquisition parameters allows the user to quickly determine that the cause of the unexpected % CV value is the change in ion spray voltage. Therefore, FIG. 5 also illustrates how the economic loss in terms of hours is prevented by comparing analytical instrument parameter values in the data files, notifying the user of differences, and allowing the user to quickly peruse the actual difference values.

As described above, parameter values can be static, dynamic, or measured. Because dynamic and measured parameter values can change all the time, comparing these values among data files can produce a large amount of false positive differences. In addition, even static parameter values can be different even though they do not represent an actual difference in the acquisition method. For example, the acquisition method file name may be included in the data file as a parameter value and, like the data file name, may vary among the different data files. As a result, there is a need for a method of removing known differences after the data files are compared.

In various embodiments, the differences found in each data file are compared to a rules file in order to verify that the differences are actual differences and not false positives. The rules file, for example, includes ranges for dynamic and measured parameter values. It can also include a notation to ignore a certain static parameter value by including a range of “any.” The rules file can be a text file that lists parameter and value range pairs.

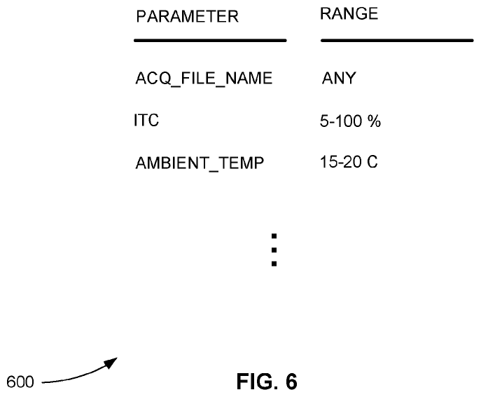

FIG. 6 is an exemplary listing 600 of a rules file, in accordance with various embodiments. Listing 600 includes two columns. The first column lists the parameter name. The second column lists the range for the corresponding parameter. For example, in the first row, the acquisition file name parameter is listed. This is a static parameter. The range provided for this parameter is the term “any,” for example. In various embodiments, any other type of notation, such as the number zero, can be used to indicate that a parameter value can have any value or should be ignored. This tells the analyzing software to ignore any differences in the acquisition file name parameter values.

In the second row, the ITC parameter is listed, which is a dynamic parameter. The range provided for this parameter is 1-100%. This means that any differences in the ITC parameter value among data files are acceptable. However, an ITC parameter value of a data file that is outside of the 1-100% range is flagged as a difference from a compared file.

Similarly, the ambient temperature parameter is listed in the third row. The range provided for this parameter is 15-20° C. This means that any differences in the ambient temperature among data files are acceptable. However, an ambient temperature parameter value of a data file that is outside of the 15-20° C. range is flagged as a difference from a compared file.

### System for Detecting Acquisition Method Differences

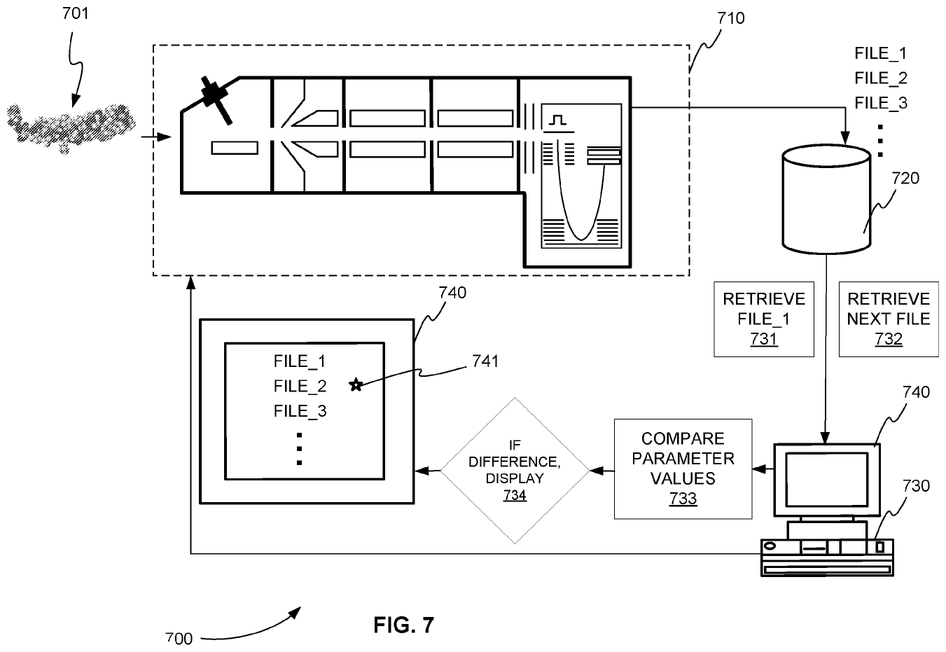

FIG. 7 is a schematic diagram 700 showing a system for detecting different acquisition methods used during sample analysis, in accordance with various embodiments. The system of FIG. 7 includes analytical instrument 710, memory device 720, processor 730, and display device 740. Memory device 720 can be any non-volatile memory including, but not limited to, a non-volatile memory of analytical instrument 710 or processor 730. Display device 740 can be any display device including, but not limited to, a display device of analytical instrument 710 or processor 730.

Analytical instrument 710 can be any type of analytical instrument used to analyze the compounds of the sample. Analytical instrument 710 can be, but is not limited to, a mass spectrometer, a chromatography device, a capillary electrophoresis (CE) device, or any combination of these devices.

Analytical instrument 710 produces intensity versus time measurements or intensity versus m/z measurements for each acquisition of n two or more sample acquisitions using m one or more instrument parameter values for each acquisition of the n acquisitions. The n two or more sample acquisitions can be from the same sample 701 or from different samples. For each acquisition of the n acquisitions, analytical instrument 710 stores a data file that includes measurements for the acquisition and m one or more instrument parameter values applied to analytical instrument 710 for the acquisition in memory device 720, producing n data files in memory device 720.

Processor 730 can be, but is not limited to, a computer, a microprocessor, the computer system of FIG. 1, or any device capable of sending and receiving control signals and data to and from memory device 720 and analytical instrument 710 and processing data.

In step 731, processor 730 retrieves a first data file of the n data files for a first acquisition from memory device 720. In step 732, processor 730 retrieves a next data file of the n data files of a next acquisition from memory device 720. In step 733, processor 730 compares the m corresponding parameter values of the first data file and the next data file. In step 734, if any corresponding parameter values differ between the first data file and the next data file, processor 730 displays a notification of an instrument parameter difference corresponding to a name of the next data file on display device 740.

In various embodiments, the notification is an icon 741 or color displayed next to the name of the next data file on display device 740. In various embodiments, processor 730 further detects a selection or mouseover of icon 741 or color and further displays a pop-up window (not shown) with the differing corresponding parameter values of the next data file. An exemplary mouseover of an icon is shown in FIG. 4.

In various embodiments, the notification is a list of the differing corresponding parameter values of the next data file displayed on display device 740 in a table of m rows representing the m one or more instrument parameter values and n columns representing the n data files. The list of the differing corresponding parameter values of the next data file are displayed in a column representing the next data file. An exemplary list of differing corresponding parameter values of a next data file is shown displayed in a column representing the next data file in FIG. 5. For example, the column for data file 21 shows a list of differing corresponding parameter values of data file 21 in FIG. 5.

Returning to FIG. 7, in various embodiments, processor 730 further displays, in a column of the table representing the first data file, each parameter value of the first data file corresponding to each of the differing corresponding parameter values of the next data file. FIG. 5, for example, further displays each parameter value of data file 1 corresponding to each of the differing corresponding parameter values of data file 21.

Returning to FIG. 7, in various embodiments, processor 730 further displays, in a column of the table representing the first data file, each parameter value of the first data file. FIG. 5 also, for example, further displays each parameter value of data file 1, including the collision energy value, which does not differ from the value of data file 21.

Returning to FIG. 7, in various embodiments, processor 730 further repeats steps 732-734 n−2 more times to detect differences among all of the n acquisitions.

In various embodiments, processor 730 further, before step 731, retrieves a list (not shown) of l known one or more acceptable instrument parameter value ranges for analytical instrument 710 from memory device 720. Processor 730 further, between steps 733 and 734, compares any corresponding parameter values that differ between the first data file and the next data file to the list. Finally, further, in step 734, if any corresponding parameter values differ between the first data file and the next data file and do not have a corresponding value range on the list or either of the differing values are outside of a corresponding value range on the list, processor 730 displays a notification of an instrument parameter difference corresponding to a name of the next data file on display device 740. FIG. 6, for example, shows an exemplary list of acceptable instrument parameter value ranges for an analytical instrument.

In various embodiments, the list can include a range for a parameter that indicates that any parameter value is acceptable for the parameter. For example, in FIG. 6 the acquisition method file name parameter includes a range that indicates that any parameter value is acceptable for the parameter.

Returning to FIG. 7, in various embodiments, processor 730 processor further repeats step 732, step 733, the step between steps 733 and 734, and step 734 n−2 more times to detect differences among all of the n acquisitions and exclude differences found within the ranges of the list of acceptable instrument parameter value ranges.

### Method for Detecting Acquisition Method Differences

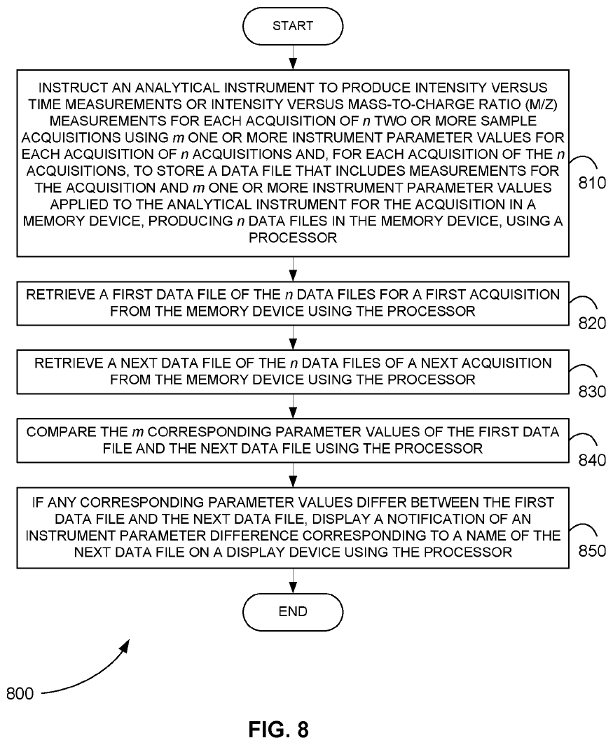

FIG. 8 is a flowchart showing a method 800 for detecting different acquisition methods used during sample analysis, in accordance with various embodiments.
In step 810 of method 800, an analytical instrument is instructed to produce intensity versus time measurements or intensity versus m/z measurements for each acquisition of n two or more sample acquisitions using m one or more instrument parameter values for each acquisition of n acquisitions using a processor. Also, for each acquisition of the n acquisitions, the analytical instrument is instructed to store a data file that includes measurements for the acquisition and m one or more instrument parameter values applied to the analytical instrument for the acquisition in a memory device, producing n data files in the memory device, using the processor.
In step 820, a first data file of the n data files for a first acquisition is retrieved from the memory device using the processor.
In step 830, a next data file of the n data files of a next acquisition is retrieved from the memory device using the processor.
In step 840, the m corresponding parameter values of the first data file and the next data file are compared using the processor.
In step 850, if any corresponding parameter values differ between the first data file and the next data file, a notification of an instrument parameter difference corresponding to a name of the next data file is displayed on a display device using the processor.

### Computer Program Product for Detecting Acquisition Method Differences

In various embodiments, a computer program product includes a non-transitory tangible computer-readable storage medium whose contents include a program with instructions being executed on a processor so as to perform a method for detecting different acquisition methods used during sample analysis. This method is performed by a system that includes one or more distinct software modules.

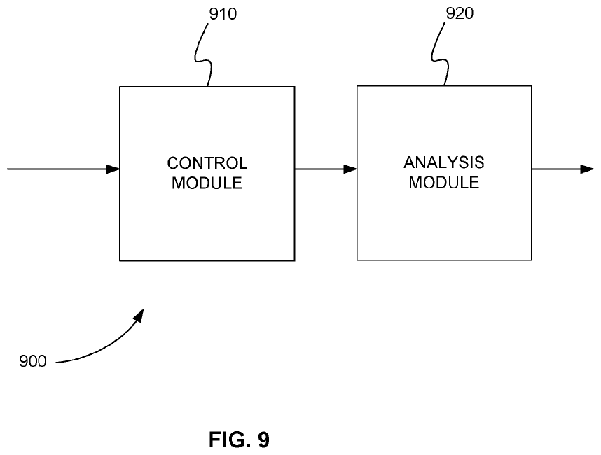

FIG. 9 is a schematic diagram of a system 900 that includes one or more distinct software modules that performs a method for detecting different acquisition methods used during sample analysis, in accordance with various embodiments. System 900 includes control module 910 and analysis module 920.

Control module 910 instructs an analytical instrument to produce intensity versus time measurements or intensity versus m/z measurements for each acquisition of n two or more sample acquisitions using m one or more instrument parameter values for each acquisition of n acquisitions. Also, for each acquisition of the n acquisitions, control module 910 instructs the analytical instrument to store a data file that includes measurements for the acquisition and m one or more instrument parameter values applied to the analytical instrument for the acquisition in a memory device, producing n data files in the memory device.

Analysis module 920 retrieves a first data file of the n data files for a first acquisition from the memory device. Analysis module 920 retrieves a next data file of the n data files of a next acquisition from the memory device. Analysis module 920 compares the m corresponding parameter values of the first data file and the next data file. If any corresponding parameter values differ between the first data file and the next data file, analysis module 920 displays a notification of an instrument parameter difference corresponding to a name of the next data file on a display device.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for detecting different acquisition methods used during sample analysis, comprising:
a memory device;
an analytical instrument that produces intensity versus time measurements or intensity versus mass-to-charge ratio (m/z) measurements for each acquisition of n two or more sample acquisitions using m one or more instrument parameter values for each acquisition of n acquisitions and, for each acquisition of the n acquisitions, stores a data file that includes measurements for the acquisition and m one or more instrument parameter values applied to the analytical instrument for the acquisition in the memory device, producing n data files in the memory device;
a display device; and
a processor that, during data analysis,
(a) retrieves a first data file of the n data files for a first acquisition from the memory device,
(b) retrieves a next data file of the n data files of a next acquisition from the memory device,
(c) compares the m corresponding parameter values of the first data file and the next data file,
(d) if any corresponding parameter values differ between the first data file and the next data file, displays a notification of an instrument parameter difference corresponding to a name of the next data file on the display device.

2. The system of claim 1, wherein the notification is an icon or color displayed next to the name of the next data file on the display device.

3. The system of claim 2, wherein the processor further detects a selection or mouse over of the icon or color and further displays a pop-up window with the differing corresponding parameter values of the next data file.

4. The system of claim 1, wherein the notification is a list of the differing corresponding parameter values of the next data file displayed on the display device in a table of m rows representing the m one or more instrument parameter values and n columns representing the n data files and wherein the list of the differing corresponding parameter values of the next data file are displayed in a column representing the next data file.

5. The system of claim 4, wherein the processor further displays in a column of the table representing the first data file each parameter value of the first data file corresponding to each of the differing corresponding parameter values of the next data file.

6. The system of claim 4, wherein the processor further displays in a column of the table representing the first data file each parameter value of the first data file.

7. The system of claim 1, wherein the processor further repeats steps (b)-(d) n−2 more times to detect differences among all of the n acquisitions.

8. The system of claim 1, wherein the processor further, before step (a), retrieves a list of/known one or more acceptable instrument parameter value ranges for the analytical instrument from the memory device, between steps (c) and (d), compares any corresponding parameter values that differ between the first data file and the next data file to the list, and in step (d) if any corresponding parameter values differ between the first data file and the next data file and do not have a corresponding value range on the list or either of the differing values are outside of a corresponding value range on the list, displays a notification of an instrument parameter difference corresponding to a name of the next data file on the display device.

9. The system of claim 8, wherein the list can include a range for a parameter that indicates that any parameter value is acceptable for the parameter.

10. The system of claim 8, wherein the processor further repeats step (b), step (c), the step between steps (c) and (d), and step (d) n−2 more times to detect differences among all of the n acquisitions.

11. The system of claim 1, wherein the analytical instrument comprises a mass spectrometer.

12. The system of claim 1, wherein the analytical instrument comprises a chromatography device.

13. The system of claim 1, wherein the analytical instrument comprises a capillary electrophoresis (CE) device.

14. A method for detecting different acquisition methods used during sample analysis, comprising:
instructing an analytical instrument to produce intensity versus time measurements or intensity versus mass-to-charge ratio (m/z) measurements for each acquisition of n two or more sample acquisitions using m one or more instrument parameter values for each acquisition of n acquisitions and, for each acquisition of the n acquisitions, to store a data file that includes measurements for the acquisition and m one or more instrument parameter values applied to the analytical instrument for the acquisition in the memory device, producing n data files in a memory device, using a processor:
retrieving a first data file of the n data files for a first acquisition from the memory device using the processor:
retrieving a next data file of the n data files of a next acquisition from the memory device using the processor:
comparing the m corresponding parameter values of the first data file and the next data file using the processor; and
if any corresponding parameter values differ between the first data file and the next data file, displaying a notification of an instrument parameter difference corresponding to a name of the next data file on a display device using the processor.

15. A computer program product, comprising a non-transitory tangible computer-readable storage medium whose contents include a program with instructions being executed on a processor for detecting different acquisition methods used during sample analysis, comprising:
providing a system, wherein the system comprises one or more distinct software modules, and wherein the distinct software modules comprise a control module and an analysis module:
instructing an analytical instrument to produce intensity versus time measurements or intensity versus mass-to-charge ratio (m/z) measurements for each acquisition of n two or more sample acquisitions using m one or more instrument parameter values for each acquisition of n acquisitions and, for each acquisition of the n acquisitions, to store a data file that includes measurements for the acquisition and m one or more instrument parameter values applied to the analytical instrument for the acquisition in the memory device, producing n data files in a memory device, using the control module;
retrieving a first data file of the n data files for a first acquisition from the memory device using the analysis module;
retrieving a next data file of the n data files of a next acquisition from the memory device using the analysis module;
comparing the m corresponding parameter values of the first data file and the next data file using the analysis module; and
if any corresponding parameter values differ between the first data file and the next data file, displaying a notification of an instrument parameter difference corresponding to a name of the next data file on a display device using the analysis module.
